(19) United States
(12) Patent Application Publication
(10) Pub. No.: US 2025/0094808 A1
(43) Pub. Date: Mar. 20, 2025

(54) METHOD AND DEVICE FOR PROCESSING FLOW SIGNALS IN REAL TIME USING ARTIFICIAL NEURAL NETWORKS

(71) Applicant: SEOUL NATIONAL UNIVERSITY R&DB FOUNDATION, Seoul (KR)

(72) Inventors: Kyung Hyun AHN, Seoul (KR); Howon JIN, Seoul (KR); Seunghoon KANG, Seoul (KR); Chan Hyeok AHN, Seoul (KR)

(21) Appl. No.: 18/570,614

(22) PCT Filed: Oct. 26, 2023
(86) PCT No.: PCT/KR2023/016733

§ 371 Date: Dec. 14, 2023

(30) Foreign Application Priority Data
Dec. 29, 2022 (KR) 10-2022-0188416

(51) Int. Cl. G06N 3/084

(52) U.S. Cl. CPC G06N 3/084

(57) ABSTRACT

The method for processing and monitoring a flow signal in real time in accordance with one exemplary embodiment of the present disclosure may include acquiring first physical data for a first fluid moving in a pipe through at least one sensor, normalizing the first physical data for the first fluid and performing recurrent mapping on the normalized first physical data to generate at least one reservoir vector of an artificial neural network, updating a parameter between the at least one reservoir vector and data output through the at least one reservoir vector based on the output data and first label data corresponding to the first physical data for the first fluid, and acquiring a second label of second physical data for a second fluid by applying the at least one reservoir vector to the second physical data based on acquiring the second physical data through the at least one sensor.

### BACKGROUND

The present disclosure relates to a method and device for processing flow signals, and more specifically, to a method and device for processing flow signals in real time using an artificial neural network.

In general, chemical plants produce various substances in large quantities through chemical reactors that generate chemical reactions. Specifically, in a chemical plant, fluid containing various chemical substances may be moved to a chemical reactor through pipes, and materials produced in the chemical reactor may be processed.

Although physical property information about a fluid (e.g., bulk properties such as pressure, a flow rate, conductivity, and the like) may be measured on a pipe through which chemical substances move, but local properties (e.g., velocity, stress, morphology, and the like) of a fluid are difficult to measure.

Bulk property measurement itself is nothing more than measuring simple physical values (that is, chaotic data), and no meaningful information is obtained through the bulk property measurement. Therefore, there is a limitation that it is difficult to monitor meaningful rheological properties related to a fluid in real time by simply measuring bulk properties.

### SUMMARY

The present disclosure has been made to overcome the limitations, and provides a method and device for processing flow signals in real time using an artificial neural network.

Problems to be solved by the present disclosure are not limited to those mentioned above, and other problems not mentioned will be clearly understood by those skilled in the art from the following description.

In accordance with an exemplary embodiment of the present disclosure, a method for processing and monitoring a flow signal in real time, performed by a device, includes acquiring first physical data for a first fluid moving in a pipe through at least one sensor, normalizing the first physical data for the first fluid and performing recurrent mapping on the normalized first physical data to generate at least one reservoir vector of an artificial neural network, updating a parameter between the at least one reservoir vector and data output through the at least one reservoir vector based on the output data and first label data corresponding to the first physical data for the first fluid, and acquiring a second label of second physical data for a second fluid by applying the at least one reservoir vector to the second physical data based on acquiring the second physical data through the at least one sensor.

In addition, the at least one sensor may include a pressure gauge, flow meter, conductivity sensor, or impedance sensor, and the first physical data and the second physical data may include pressure, flow rate, conductivity, or impedance of the fluid.

In addition, the normalizing may include reducing a dimensionality of the first physical data by performing principal component analysis on the first physical data, acquiring a trend line by performing linear regression analysis on the first physical data of which the dimensionality has been reduced, removing a trend from the first physical data of which the dimensionality has been reduced based on the trend line and acquiring a standard deviation from the first physical data from which the trend has been removed, and normalizing the first physical data by dividing the first physical data by the standard deviation.

In addition, the first label data corresponding to the first physical data may be acquired by performing one-hot encoding on a label of the first physical data.

In addition, the updating may include calculating an error between the data output through the at least one reservoir vector and the first label data corresponding to the first physical data for the first fluid and updating the parameter between the at least one reservoir vector and the output data so that the calculated error is reduced.

In addition, the acquiring of the second label may include acquiring the second physical data for the second fluid through the at least one sensor for a plurality of time units, acquiring a plurality of pieces of output data by applying the reservoir vector to each piece of the second physical data acquired for each of the plurality of time units, and acquiring second label data that is an average of the plurality of pieces of output data.

In addition, the acquiring of the second label may include acquiring the second label by decoding the second label data, and the second label may contain information regarding physical properties of the second fluid.

In addition, the updating may include updating the parameter based on a Stochastic gradient descent (SGD) algorithm or an adaptive moment estimation (ADAM) algorithm, based on definition that a non-linear operation is performed on the at least one reservoir vector.

In accordance with another exemplary embodiment of the present disclosure, a device for processing and monitoring a flow signal in real time includes one or more communication modules, one or more memories, and one or more processors, and the one or more processors are configured to acquire first physical data for a first fluid moving in a pipe through at least one sensor, normalize the first physical data for the first fluid and perform recurrent mapping on the normalized first physical data to generate at least one reservoir vector of an artificial neural network, update a parameter between the at least one reservoir vector and data output through the at least one reservoir vector based on the output data and first label data corresponding to the first physical data for the first fluid, and acquire a second label of second physical data for a second fluid by applying the at least one reservoir vector to the second physical data based on acquiring the second physical data through the at least one sensor.

In addition, a computer program stored in a computer-readable recording medium for execution to implement the present disclosure may be further provided.

In addition, a computer-readable recording medium recording a computer program for executing a method for implementing the present disclosure may be further provided.

### BRIEF DESCRIPTION OF THE DRAWINGS

Exemplary embodiments can be understood in more detail from the following description taken in conjunction with the accompanying drawings, in which:

FIG. 1 is a diagram for describing a method for acquiring a flow signal in real time in accordance with one exemplary embodiment of the present disclosure;

FIG. 2 is a block diagram briefly illustrating a configuration of a device for processing a flow signal in real time using an artificial neural network, in accordance with one exemplary embodiment of the present disclosure;

FIG. 3 is a flowchart for describing a method for processing a flow signal in real time using an artificial neural network, in accordance with one exemplary embodiment of the present disclosure;

FIG. 4 is a diagram for describing a structure and operation of an echo state network (ESN) in accordance with one exemplary embodiment of the present disclosure;

FIGS. 5 and 6 are diagrams for describing data for ESN learning in accordance with one exemplary embodiment of the present disclosure; and

FIGS. 7 and 8 are diagrams for describing data output through an ESN in accordance with one exemplary embodiment of the present disclosure.

### DETAILED DESCRIPTION OF EMBODIMENTS

Advantages and features of the present disclosure, and methods for achieving the advantages and features will be clarified with reference to embodiments described below in detail together with the accompanying drawings. However, the present disclosure is not limited to the exemplary embodiments disclosed below, but will be implemented in a variety of different forms. The present embodiments are only provided to allow the present disclosure to be complete, and to completely inform those skilled in the art of the scope of the present disclosure, and the present disclosure is merely defined by scope of the claims.

The terms used herein are for the purpose of describing particular embodiments only and are not intended to limit the present disclosure. As used herein, the singular forms “a”, “an”, and “the” are intended to include the plural forms as well, unless the context clearly indicates otherwise. It will be further understood that the terms “comprises” and/or “comprising”, when used herein, do not preclude the presence or addition of one or more other elements in addition to stated elements.

Throughout the specification, like reference numerals refer to like elements, and “and/or” includes each and every combination of one or more of stated elements. Although “first”, “second”, etc. are used to describe various elements, these elements are of course not limited by these terms. These terms are merely used to distinguish one element from another. Therefore, it goes without saying that a first element mentioned below may also be a second element within the technical spirit of the present disclosure.

Unless otherwise defined, all terms (including technical and scientific terms) used herein have the same meaning as commonly understood by one of those skilled in the art to which the present disclosure pertains. In addition, it will be further understood that terms, such as those defined in commonly used dictionaries, will not be interpreted in an idealized or overly formal sense unless expressly so defined herein.

Spatially relative terms such as “below”, “beneath”, “lower”, “above”, “upper”, or the like, may be used to easily describe the correlation between one element and another element as shown in the drawings. Spatially relative terms should be understood as terms that include different directions of elements during use or operation in addition to the directions shown in the drawings.

For example, when flipping an element shown in a drawing, the element described as “below” or “beneath” another element will be positioned “above” the other element. Accordingly, the illustrative term “below” may include both downward and upward directions. Components may also be oriented in other directions, and thus spatially relative terms may be interpreted according to orientation.

In describing the present disclosure, a “device” may include a smartphone, laptop, desktop, laptop, tablet PC, slate PC, server device, wearable device, or the like. As another example, a “device” may mean a group of devices in which two or more types of devices are connected wirelessly or by wires.

Hereinafter, a method and device for processing a flow signal in real time using an artificial neural network will be described in detail with reference to the drawings.

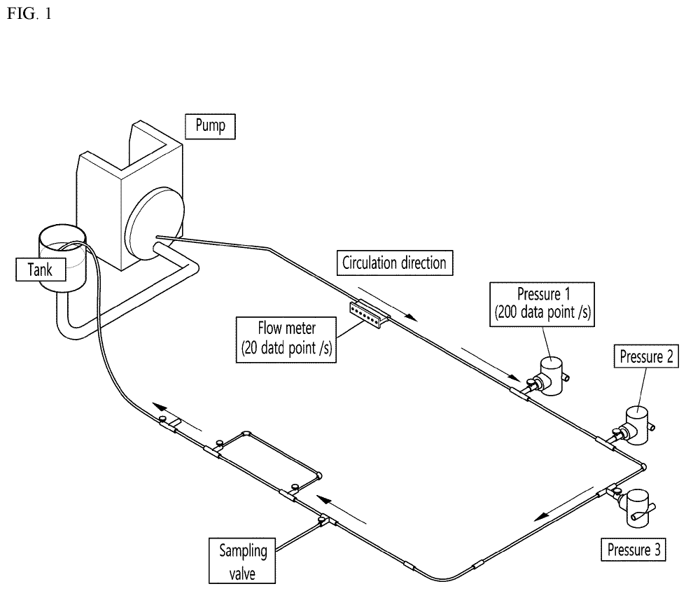

FIG. 1 is a diagram for describing a method for acquiring a flow signal in real time in accordance with one exemplary embodiment of the present disclosure.

A device may acquire a flow signal (or physical data) of a fluid moving through a pipe in real time through at least one sensor. As one example, the at least one sensor may include a pressure gauge, flow meter, conductivity sensor, or impedance sensor. The at least one sensor may be mounted at a specific position in the pipe through which a fluid moves.

As one example, as illustrated in FIG. 1, the device may acquire flow signals of a fluid circulating in the pipe (by a pump) through a plurality of pressure gauges and flow meters. The device may acquire fluid flow signals measured from a plurality of pressure gauges and flow meters in real time.

Here, the device may be electrically connected to at least one sensor. As another example, the device may be connected to at least one sensor using wireless communication over a network. The device may acquire a flow signal of the fluid from at least one sensor in real time using wireless communication.

Here, the network may include a wired network and a wireless network. For example, the network may include various networks such as a local area network (LAN), a metropolitan area network (MAN), and a wide area network (WAN).

The device may normalize the received flow signals of the fluid and generate a hidden state vector (or a vector on a hidden layer) of an artificial neural network model based on the normalized flow signals.

Here, the artificial neural network means a machine learning model created based on the structure of human neurons. The artificial neural network may include an input layer, an intermediate layer (or hidden layer), and an output layer. Various parameters (weights) may be set on the input layer, intermediate layer, and output layer, and data may be output through the output layer through calculation of the input data and each weight.

In addition, the device may update/learn parameters (e.g., weights and the like) included in the hidden state vector based on a label matched to the flow signal and data output through the hidden state vector.

Accordingly, the device may predict/calculate the label of the flow signal by additionally inputting the flow signal acquired through at least one sensor into the hidden state vector for which learning is done. Here, the label of the fluid flow signal may include (classification) information indicating (or representing) the physical properties of the fluid.

In addition, in describing the present disclosure, “training the artificial neural network” may mean “updating a plurality of parameters used in the calculation of the artificial neural network to optimal values.”

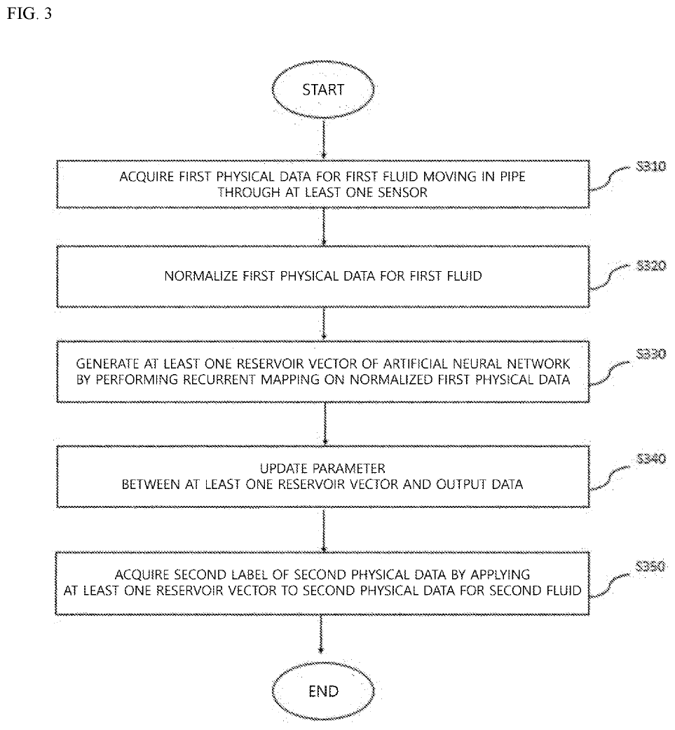

A method for processing a flow signal in real time using an artificial neural network by the device will be described in detail with reference to FIGS. 3 to 8.

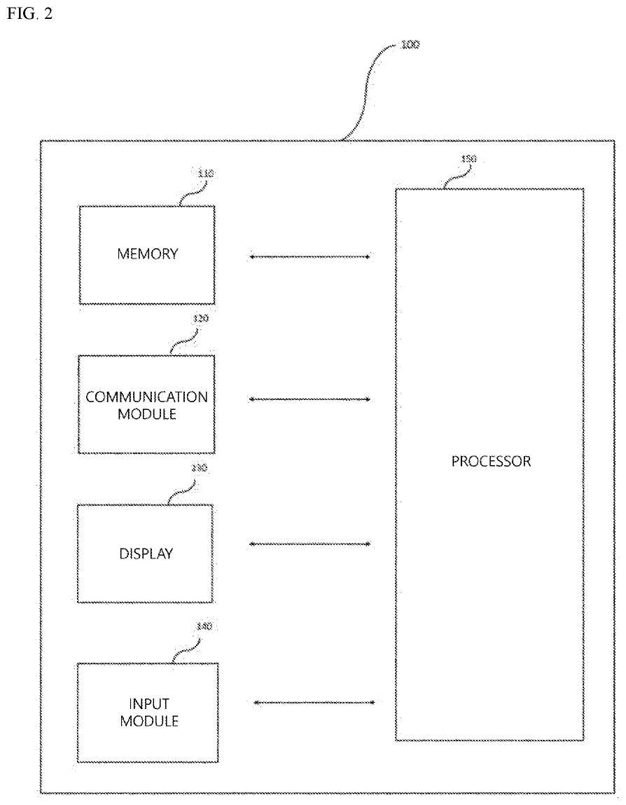

FIG. 2 is a block diagram briefly illustrating a configuration of a device for processing a flow signal in real time using an artificial neural network, in accordance with one exemplary embodiment of the present disclosure.

As illustrated in FIG. 2, the device 100 may include a memory 110, a communication module 120, a display 130, an input module 140, and a processor 150. However, the device 100 is not limited to including only the aforementioned components, and may have software and hardware configurations modified, added, or omitted within a range apparent to those skilled in the art depending on required operation.

The memory 110 may store data supporting various functions of the device 100 and a program for the operation of the processor 150, may store input/output data (e.g., physical data for the fluid, parameters included in the reservoir vector, or the like), and store a number of application programs (application programs or applications) running on the device, data for operating the device 100, and instructions. At least some of the application programs may be downloaded from an external server through wireless communication.

The memory 110 may include at least one type of storage medium of a flash memory type memory, a hard disk type memory, a solid state disk (SSD) type memory, a silicon disk drive (SDD) type memory, a multimedia card micro type memory, a card type memory (for example, SD or XD memory), a random access memory (RAM), a static random access memory (SRAM), a read-only memory (ROM), an electrically erasable programmable read-only memory (EEPROM), a programmable read-only memory (PROM), a magnetic memory, a magnetic disk, and an optical disc.

In addition, the memory 110 is separate from the device, but may include a database connected by wire or wirelessly. That is, the database may be implemented as one component of the memory 110.

The communication module 120 may include one or more components that enable communication with an external device, and for example, the communication module 120 may receive physical data for a fluid from at least one sensor.

For example, the communication module 120 may include at least one of a broadcast reception module, a wired communication module, a wireless communication module, a short-range communication module, and a location information module.

The wired communication module may include various type of wired communication modules such as a local area network (LAN) module, a wide area network (WAN) module, or a value added network (VAN) module as well as various types of cable communication modules such as a universal serial bus (USB) module, a high definition multimedia interface (HDMI) module, a digital visual interface (DVI) module, a recommended standard 232 (RS-232), a power line communication module, or a plain old telephone service (POTS) module.

In addition to the Wi-Fi module and a wireless broadband (WiBro) module, the wireless communication module may include a wireless communication module that supports various wireless communication methods such as global system for mobile Communication (GSM), code division multiple access (CDMA), wideband code division multiple access (WCDMA), universal mobile telecommunications system (UMTS), time division multiple access (TDMA), long term evolution (LTE), 4G, 5G, and 6G.

The display 130 displays (outputs) information processed by the device 100 (e.g., physical data for the fluid, data output through a reservoir vector, update results of various parameters, and the like). For example, the display may display execution screen information about an application program (e.g., an application) running on the device 100, or a user Interface (UI) and a graphic user interface (GUI) information according to the execution screen information.

The input module 140 is for receiving information from a user, and when information is input through a user input unit, the processor 150 may control the operation of the device 100 to correspond to input information.

The input module 140 may include hardware-type physical keys (e.g., buttons, dome switches, jog wheels, jog switches, or the like positioned on at least one of the front, rear, and sides of the device) and software-type touch keys. As one example, the touch keys may include a virtual key, soft key, or visual key displayed on the touch screen type display 130 through software processing, or a touch key disposed in a part other than the touch screen. Meanwhile, the virtual key or visual key may be able to be displayed on the touch screen in various forms, and may include, for example, graphic, text, icon, video or a combination thereof.

The processor 150 may control the overall operation and functions of the device 100. Specifically, the processor 150 may be implemented with a memory for storing data for an algorithm for controlling the operation of components in the device 100 or a program for reproducing the algorithm and at least one processor (not illustrated) for performing the aforementioned operations using the data stored in the memory. In this case, the memory and the processor may each be implemented as separate chips. Alternatively, the memory and the processor may be implemented as a single chip.

In addition, the processor 150 may control any one or a combination of a plurality of the above-described components to implement various embodiments according to the present disclosure to be described in FIGS. 3 to 8 below on the device 100.

FIG. 3 is a flowchart for describing a method for processing a flow signal in real time using an artificial neural network, in accordance with one exemplary embodiment of the present disclosure.

A device may acquire first physical data (or flow signal) for a first fluid moving in a pipe through at least one sensor (S310).

In this case, the device may acquire the first physical data for the first fluid moving in the pipe through at least one sensor for a plurality of time units. The time unit may be set to the time for the fluid to circulate once in the pipe, but is not limited thereto and may be set by the device.

Further, the at least one sensor may include a pressure gauge, flow meter, conductivity sensor, or impedance sensor. In addition, the first physical data may include pressure, flow rate, conductivity, or impedance of the fluid.

The device may normalize the first physical data for the first fluid (S320).

Specifically, the device may reduce a dimensionality of the first physical data by performing principal component analysis on the first physical data. Principal component analysis means a method for converting data of a high-dimensional space to a low-dimensional space while preserving distribution of existing data as much as possible.

The device may acquire a trend line by performing linear regression analysis on the first physical data of which the dimensionality has been reduced. Linear regression analysis means an analysis method for modeling a relationship between variables in a linear function under the premise that there is a linear relationship between independent and dependent variables. The trend line means a line representing the distribution or tendency of first physical data.

The device may remove a trend (e.g., data away from the trend line by a predefined distance) for the first physical data of which the dimensionality has been reduced based on the trend line and acquire a standard deviation from the first physical data from which the trend has been removed. The device may normalize the first physical data by dividing the first physical data by the standard deviation.

The device may generate at least one reservoir vector of the artificial neural network by performing recurrent mapping on the normalized first physical data (S330).

When the artificial neural network is an echo state network (ESN), the reservoir vector may refer to a hidden state vector. The ESN means an artificial neural network created based on a recurrent neural network (RNN).

The RNN means a sequence model that processes input data and output data in sequence units. That is, the RNN may transfer a result value calculated through the activation function at a node of the hidden layer to an output layer, and at the same time, transfer the result value back as an input of next calculation at a node of the hidden layer. Recurrent mapping may mean performing an operation between the first physical data and the hidden layer of the RNN.

The ESN means a network that randomly generates an RNN and then learns only parameters (or weights) between the node of the output layer and the node of the hidden layer. That is, the weight on the node of the hidden layer and the weight between the nodes of the hidden layer may not be learned at the node of the input layer.

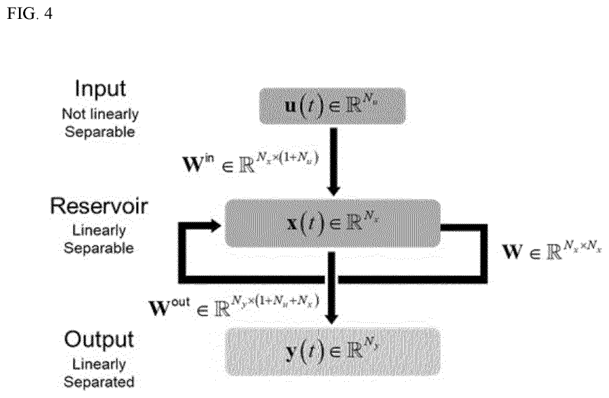

Referring to FIG. 4, data that is not linear as the input layer may perform operations with the reservoir vector. Output data may be linear due to linear mapping of the reservoir vector.

The device may perform circular mapping to calculate a reservoir vector x(n=1, 2, . . . T) for the first physical data.

The type and size Nu of the input may be determined based on the type and size of the first physical data output through at least one sensor. The size Nₓ of the reservoir vector has to be satisfy T>1+Nᵤ+Nₓ when a total time step (or unit time) is defined as T.

The larger the size of the reservoir vector, the better the ESN's calculation performance, and thus the size of the reservoir vector may be increased closer to an upper limit of the memory or calculation ability of the device.

An operation equation performed in the reservoir vector may be implemented as Equation 1 and Equation 2. Here, α may be 0 or 1.

$$\tilde{x} ( n ) = tanh ( {W}^{in} [ 1 ; u ( n ) ] + Wx ( n - 1 ) , where W ∈ {{N}_{x} \times {N}_{x}}^{} , {W}^{i n} ∈ {{N}_{x} \times ( 1 + {N}_{u} )}^{} \qquad [ Equation 1 ]$$

$$x ( n ) = ( 1 - α ) x ( n - 1 ) + α \tilde{x} ( n ) \qquad [ Equation 2 ]$$

Further, a value W^{out} output from the reservoir vector may be implemented as in Equation 3.

$$Y = {W}^{out} ( {X}^{res} = [ 1 ; U ; X ] ) , where {W}^{out} ∈ {{N}_{y} \times ( 1 + {N}_{u} + {N}_{x} )}^{} \qquad [ Equation 3 ]$$

$$\text{?} \qquad [ Equation 4 ]$$

$$\text{?} \text{indicates text missing or illegible when filed}$$

The device may update parameters between at least one reservoir vector and output data (S340).

The device may update the parameters between the at least one reservoir vector and data output through the at least one reservoir vector based on the output data and first label data corresponding to the first physical data for the first fluid.

In this case, learning is not performed in an operation stage of the reservoir vector, and learning may be performed only in a stage where the reservoir vector is converted to output data. That is, learning/updating may be performed only on parameters between a node corresponding to the reservoir vector and a node corresponding to the output node.

Specifically, the device may preset first label data for the first physical data. Here, the first label may include information regarding physical properties of the first fluid (that is, information capable of representing the physical properties of the first fluid). The device may acquire the first label data by performing one-hot encoding on the first label.

Here, one-hot encoding means a method for expressing a word in a vector form by setting a size of a classification set to the dimension of the vector, and assigning 1 to an index of a word to be expressed and 0 to other indices.

The device may calculate an error between the data output through the at least one reservoir vector and the first label data corresponding to first physical data for the first fluid. Since the data output through the reservoir vector is also one-hot encoded vector data, the device may calculate the error by calculating a distance/difference between the two vectors. The device may update parameters between the at least one reservoir vector and the output data so that the calculated error is reduced (that is, minimized).

That is, by updating the parameters between at least one reservoir vector and the output data using a supervised learning method, the device may train the artificial neural network including the reservoir vector to output label data corresponding to physical data through the physical data.

Further, as one example, the device may update the parameters based on a Stochastic gradient descent (SGD) algorithm or an adaptive moment estimation (ADAM) algorithm, based on definition that a non-linear operation is performed on the at least one reservoir vector. However, this is only an example, and the device may update the parameters by performing a direct inverse matrix operation on at least one reservoir vector and/or output data.

As another example, based on the definition that a linear operation is performed on at least one reservoir vector, a matrix W^{out}(∈ [symbol] ^{N}^{_{y}}^{×(1+N}^{ᵤ}^{+N}^{ₓ}⁾ used for linear mapping of the reservoir vector may be implemented as Equation 5 together with a hyper-parameter β.

$${W}^{out} = {Y}^{target} {{X}^{T} ( ( {X}^{res} ) {( {X}^{res} )}^{T} + β I )}^{- 1} ( {X}^{res} = [ 1 ; U ; X ] ) \qquad [ Equation 5 ]$$

Based on β, the reservoir vector may be classified into training data and test data. The device may learn the parameters through training data and then perform inference operations through test data.

Optimal values for the type and number Nᵤ of input data (i.e., first physical data) may be calculated through testing various combinations. Further, random search, grid search, or Bayesian optimization techniques may be used to calculate the optimal values of all hyperparameters c, a, ρ, α, Nₓ required to generate the reservoir vector.

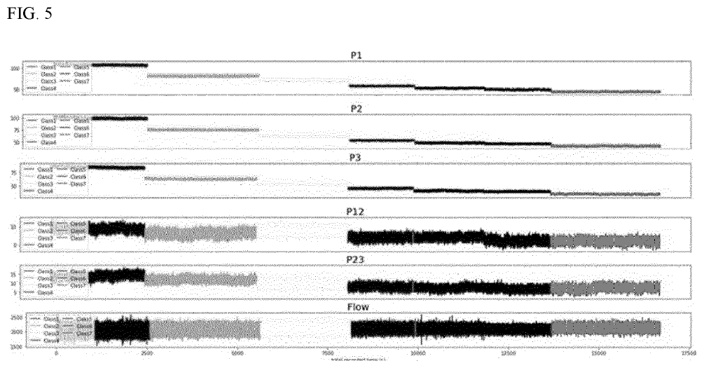

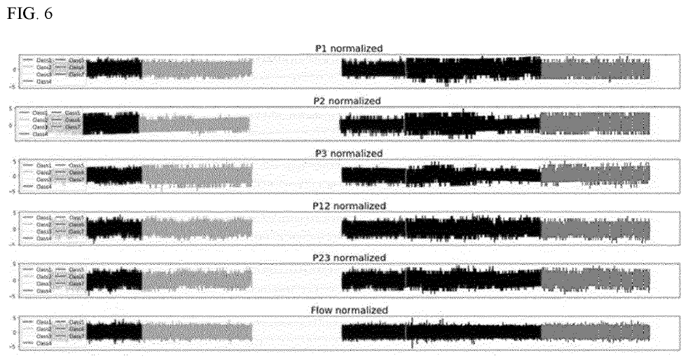

As one example, FIG. 5 illustrates training data. As one example, the device may acquire a first physical data set for the first fluid for seven days, and each class may mean the first physical data set measured for each day. The first physical data set may be easily distinguished by its mean and variance. That is, the first physical data set may have a trend by time. FIG. 6 illustrates a case where normalization is performed on training data in FIG. 5.

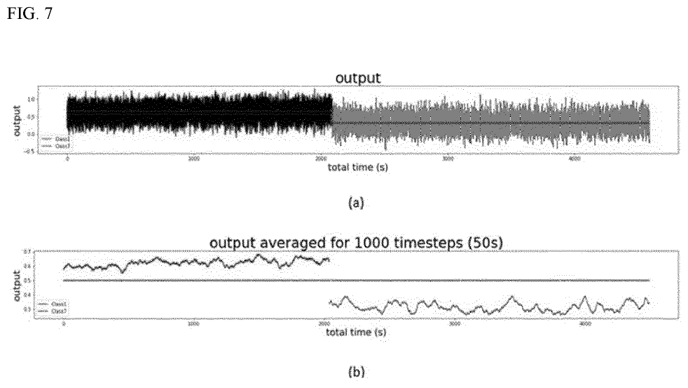

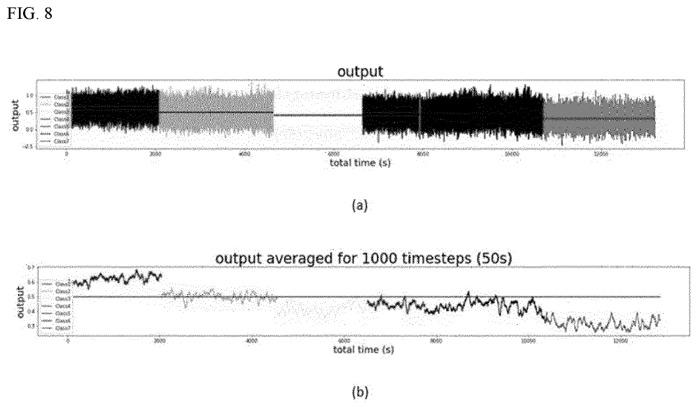

FIGS. 7 and 8 illustrate results output by applying the reservoir vector to the training data.

For example, the input data may be any combination of physical data (e.g., pressure, a flow rate, or the like of the first fluid). Further, a size Nₓ of the reservoir vector may be 10⁴, an input scaling of Wⁱⁿ, a, may be 1, a spectral radius p^{(W)} of w may be

$${max}_{\text{?}} \vert {λ}_{i} \vert = 1 ,$$

$$\text{?} \text{indicates text missing or illegible when filed}$$

and a leaking ratio (α) may be 1. The output data may be implemented as binary values for the first or last day or as multi-class classification information.

The device may acquire a second label of second physical data for a second fluid by applying at least one reservoir vector to the second physical data (S350). Here, the second fluid may mean a fluid different from the first fluid, that is, a fluid not used for learning.

The device may acquire the second label of the second physical data for a second fluid by inputting the second physical data for the fluid into at least one reservoir vector based on acquiring the second physical data through the at least one sensor.

Specifically, since the parameters related to at least one reservoir vector are optimized through learning, the device may acquire second label data for the second physical data by inputting the second physical data for the second fluid into an artificial neural network including at least one reservoir vector. The device may acquire information regarding physical properties of the second physical data (that is, information representing the physical properties of the second fluid) by decoding the second label data.

As another example, the device may acquire the second physical data for the second fluid for a plurality of time units through at least one sensor. The device may acquire a plurality of pieces of output data by applying the reservoir vector to each piece of the second physical data acquired for each of the plurality of time units. The device may acquire the second label data, which is an average of a plurality of pieces of output data, and acquire information regarding the physical properties of the second physical data by decoding at least one of the second label data or the reservoir vector.

Meanwhile, the disclosed embodiments may be implemented in the form of a recording medium storing instructions executable by a computer. Instructions may be stored in the form of program codes, and when executed by a processor, may create program modules to perform operations of the disclosed embodiments. The recording medium may be implemented as a computer-readable recording medium.

The computer-readable recording medium includes all types of recording media in which instructions capable of being decoded by a computer are stored. For example, there may be a read only memory (ROM), a random-access memory (RAM), a magnetic tape, a magnetic disk, a flash memory, an optical data storage device, and the like.

In accordance with one exemplary embodiment of the present disclosure, a method and device for processing flow signals in real time using an artificial neural network can be provided.

In accordance with one exemplary embodiment of the present disclosure, physical property information about a fluid can be more efficiently ascertained based on physical information on the fluid that is able to be easily measured using the artificial neural network.

Effects of the present disclosure are not limited to those mentioned above, and other effects not mentioned will be clearly understood by those skilled in the art from the description below.

As above, the disclosed embodiments have been described with reference to the accompanying drawings. It will be understood by those skilled in the art that various changes in form and details may be made therein without departing from the spirit and scope of the disclosure as defined by the appended claims and their equivalents. The disclosed embodiments are illustrative and should not be construed as limiting.

1. A method for processing and monitoring a flow signal in real time, performed by a device, the method comprising:
acquiring first physical data for a first fluid moving in a pipe through at least one sensor;
normalizing the first physical data for the first fluid and performing recurrent mapping on the normalized first physical data to generate at least one reservoir vector of an artificial neural network;
updating a parameter between the at least one reservoir vector and data output through the at least one reservoir vector based on the output data and first label data corresponding to the first physical data for the first fluid; and
acquiring a second label of second physical data for a second fluid by applying the at least one reservoir vector to the second physical data based on acquiring the second physical data through the at least one sensor.

2. The method of claim 1, wherein the at least one sensor includes a pressure gauge, flow meter, conductivity sensor, or impedance sensor, and
the first physical data and the second physical data include pressure, flow rate, conductivity, or impedance of the fluid.

3. The method of claim 1, wherein the normalizing comprises:
reducing a dimensionality of the first physical data by performing principal component analysis on the first physical data;
acquiring a trend line by performing linear regression analysis on the first physical data of which the dimensionality has been reduced;
removing a trend from the first physical data of which the dimensionality has been reduced based on the trend line and acquiring a standard deviation from the first physical data from which the trend has been removed; and
normalizing the first physical data by dividing the first physical data by the standard deviation.

4. The method of claim 1, wherein the first label data corresponding to the first physical data is acquired by performing one-hot encoding on a label of the first physical data.

5. The method of claim 1, wherein the updating comprises:
calculating an error between the data output through the at least one reservoir vector and the first label data corresponding to the first physical data for the first fluid; and
updating the parameter between the at least one reservoir vector and the output data so that the calculated error is reduced.

6. The method of claim 1, wherein the acquiring of the second label comprises:
acquiring the second physical data for the second fluid through the at least one sensor for a plurality of time units;
acquiring a plurality of pieces of output data by applying the reservoir vector to each piece of the second physical data acquired for each of the plurality of time units; and
acquiring second label data that is an average of the plurality of pieces of output data.

7. The method of claim 6, wherein the acquiring of the second label comprises acquiring the second label by decoding the second label data, and
the second label contains information regarding physical properties of the second fluid.

8. The method of claim 1, wherein the updating comprises updating the parameter based on a Stochastic gradient descent (SGD) algorithm or an adaptive moment estimation (ADAM) algorithm, based on definition that a non-linear operation is performed on the at least one reservoir vector.

9. A device for processing and monitoring a flow signal in real time, the device comprising:
one or more communication modules;
one or more memories; and
one or more processors,
wherein the one or more processors are configured to:
acquire first physical data for a first fluid moving in a pipe through at least one sensor;
normalize the first physical data for the first fluid and perform recurrent mapping on the normalized first physical data to generate at least one reservoir vector of an artificial neural network;
update a parameter between the at least one reservoir vector and data output through the at least one reservoir vector based on the output data and first label data corresponding to the first physical data for the first fluid; and
acquire a second label of second physical data for a second fluid by applying the at least one reservoir vector to the second physical data based on acquiring the second physical data through the at least one sensor.

10. A computer program combined with a device that is hardware device and stored in a computer-readable recording medium to execute the method of processing and monitoring a flow signal in real time of claim 1.
